(19) United States
(12) Patent Application Publication
(10) Pub. No.: US 2009/0205251 A1
(43) Pub. Date: Aug. 20, 2009

(54) Flower Pot

(75) Inventor: Günter Irmler, Hamburg (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: BIKH-Lizenz GbR, Hamburg (DE)

(21) Appl. No.: 12/308,162

(22) PCT Filed: Jul. 7, 2006
(86) PCT No.: PCT/EP2006/006647

§ 371 Date: Dec. 5, 2008

(51) Int. Cl. A01G 9/02

(52) U.S. Cl. 47/79

(57) ABSTRACT

The present invention relates to a flower pot (100) comprising an outer pot (10), which is open toward the lop and encompasses an inner space, wherein the outer pot (10) is provided with openings (42) in the lower region for ventilating the inner space, furthermore comprising an inner pot (30) open toward the top for receiving plant substrate, wherein the inner pot (30) can be inserted in the outer pot (10), a water holding area (40) comprising a water reservoir (47), which is provided such that moisture exchange is possible between the inner pot (30) and the water reservoir (47), and a water replenishing element (50), which enables targeted filling of the water holding area (40) when the inner pot (30) is inserted in the outer pot (10). According to the invention, this flower pot (100) provides that the inner pot (30) is placed in the outer pot (10) and rests on the water holding area (40), wherein the inner pot bottom (36) is provided with at least one recess (38) directed toward the upper opening of the inner pot, wherein the recess height is greater than the maximum water level of the water in the water reservoir (47) of the water holding area (40).

### CROSS-REFERENCE TO RELATED APPLICATIONS

The present application is a national phase entry under 35 U.S.C. § 371 of International Application No. PCT/EP2006/006647 filed Jul. 7, 2006, published in German, which is incorporated herein by reference.

### BACKGROUND OF THE INVENTION

Plant pots are known in a great variety of types and forms. In the simplest case, they consist of a pot-like container that receives the plant substratum together with the roots of a plant. Plant substratum is understood to mean the material that is placed in the pot-like containers and in which the plant's roots are bedded. Plant substrata store air, water and nutrients. Examples of plant substrata are soil, sand, clay, pumice, lava, turf or peat. Since the containers are easily soiled and damaged by the plant substratum, the plants themselves and water and nutrients that are added, they are usually made of plastic and designed to be purely functional. In order to improve the outer appearance of the plants that are generally used as house- or garden decorations with their plant pots, the containers described are generally placed as an inner pot in an outer pot that can more easily be given the desired appearance and that is often made of ceramic or clay.

For the selection of a construction of a plant pot, however, only aesthetic aspects play a role. Particularly for house plants, it is important that the plant, which must exist outside its natural environment and which, in contrast to outdoor plants, has only a severely limited space for its roots, be given the optimal living conditions. These are a function of factors such as light- and temperature conditions, as well as the supply of water and air to the plants. The last two factors are influenced by the plant pot.

Plants confined to a container are usually supplied with water in that water is poured on the plant substratum. In this, the person who is taking care of the plants must be careful that the roots of the plants neither dry out nor are exposed to accumulated wetness. This requires not only regular and careful pouring, but also dosing with the right quantity of water with each pouring.

In addition, for all plants, good ventilation of their roots is desirable, in order to prevent rotting of the roots, and plants also absorb materials from the air for their metabolism. For some plants, such as, for example, epiphytically-grown orchids or ferns, the air supply to the roots is even essential. In order to improve the ventilation to the root structure, plant pots are known that have openings for air circulation.

The required water- and air supply to the roots are not independent of one another. Thus, too great a supply of water without additional measures result in accumulated wetness in the plant substratum, which leads to inadequate aeration of the root area and eventually to a rotting of the roots and the decay of the plants. Conversely, a high degree of air circulation with an inadequate water supply may contribute to a faster drying-out of the plant substratum and the roots. In addition to the lack of water for the plants, this has the disadvantage that the re-wetting of the dried-out plant substratum is generally very difficult.

For these reasons, the right living conditions can be maintained only with difficulty and with a relatively high investment of time. Thus, persons who do not have sufficient experience are often not able to keep a plant alive over a long period of time. This has the consequence that many people do without plants in their home- or work environment, although it is known that plants can have a positive influence on health, even beyond oxygen production. There are plants, for example, that can filter or eliminate toxic substances and dangerous gases produced by building materials, pieces of equipment or electronic devices, and in this way provide room air that is clean, oxygen-rich, and low in hazardous materials. For example, special plants are known that can absorb targeted substances that have been called responsible for the group of complaints and illnesses such as allergies, respiratory problems or cancer known as “sick building syndrome”, and convert them to harmless substances such as oxygen. Many of these plants, however, come from tropical or sub-tropical areas and therefore require living conditions that they would not easily find as houseplants. The air purification therefore takes place primarily not through the chlorophyll, but rather almost exclusively through the roots, and the plant substratum that surrounds them, so that in this regard, too, good air circulation in the root area is of great significance.

In order to counter the problems in connection with the care or maintaining of plants, plant pots have been developed with the goal of preventing the wrong watering of the plants and/or insufficient ventilation of the root area, with the least possible effort for people. Such plant pots generally have an inner pot open on top to receive the plant substratum, an outer pot or outer casing open on top to receive the inner pot and a water reservoir that may be designed as a base for the outer pot or as a separate container. The walls of the inner pot often have openings through which air can reach the inner pot. Furthermore, the inner pot is connected with the water reservoir in such a way that water can be exchanged between the inner pot and the water reservoir. Such an arrangement has the advantage that water that is not immediately taken up by the roots, and cannot be stored in the plant substratum is taken into the water reservoir, stored temporarily and can then be fed into the inner pot, if the roots need water again. In this manner, in the ideal case both accumulated wetness, with the associated lack of ventilation of the roots, as well as the drying out of the roots, can be prevented. Furthermore, the watering intervals are lengthened. However, the aforementioned goals have not been sufficiently realized by the known plant pots.

From DE 91 12 058 U1, a plant pot for the individual planting of orchids is known. This has an inner pot to receive the plant substratum and the plant and an outer pot that has ventilation openings in the upper part of its side wall. The inner pot has, in its side wall and in its base, also has ventilation openings, and is placed in the outer pot in such a way that its base is at a certain distance above the base of the outer pot. In this way, the interior space of the outer pot that is located under the inner pot is designed as a water reservoir. In order to supply the plants with water, water is poured, up to a maximum fill height, into the outer pot, which lies under the base of the inner pot. The water supply then takes place by means of evaporated water that enters the inner pot through openings in its base and walls. This construction has the disadvantage that when too much water is poured, the base of the perforated pot can come in contact with the water in the reservoir, with the result that the plant substratum becomes too wet, and furthermore, air circulation through the ventilation openings is impossible or possible only to a limited extent.

WO 02/082884 discloses a plant pot that has a perforated pot to receive plant substratum, a supporting insert that serves as water storage, on which the perforated pot is placed, and a cover or outer casing in which the perforated pot and supporting insert are each connected in a detachable manner. The cover widens toward the bottom in a conical shape, so that between the perforated pot or supporting insert and the cover there is an air slot that goes around and is closed on the bottom and on the top, through which ventilation can take place. This design has the disadvantage that it is complicated, and that maintenance of the plant basket or water storage requires great effort, since many individual components must be disassembled. Furthermore, only limited ventilation is possible, since adequate air flow cannot be maintained in the air slot due to the plant substratum being only poorly permeable to air. This arrangement has an additional disadvantage in that the plant pot must be assembled before planting. Subsequent replacement of the visible and thus decorative outer pot is not possible or possible only with great effort, since this would have to be pushed over the plant.

A further disadvantage of such known plant pots has its cause in that the outer casing or outer pot is often made of ceramic or clay, and the inner pot and any separate water storage are generally made of plastic. Since ceramic parts, unlike plastic, cannot be made with a high degree of accuracy in terms of their shape, there is a danger that the individual components cannot be placed at the intended distance from one another. For example, due to imprecise form, the inner pot cannot be placed relative to the water storage in such a way that the base of the inner pot, for example, comes into direct contact with the water in the reservoir. Furthermore, there is a danger that because of the varying dimensions, the assembly of the components is impossible, or possible only with difficulty. This can also lead to the plant pot being unstable.

From WO 2006/058721 another plant pot of the aforementioned type is known. Here the inner pot is hung on a casing that forms an outer pot. On the inner pot there is an outward-facing collar that is provided with opening, for the outlet of air that has entered through the openings in the casing and climbed flue-like into the intermediate space. The water storage is detachably attached to the inner pot. The inner pot is provided with an area in which a water level indicator is inserted. One embodiment of the water level indicator provides that the water storage can be filled through the inner tube of the water level indicator.

What might be improved on this plant pot is that the manufacturing tolerances required are very narrow, so that production must be carried out very carefully, which leads to higher product costs. Furthermore, theoretically, in the case of heavy plants, the inner pot can slide around in the outer pot and get wedged in.

### BRIEF SUMMARY OF THE INVENTION

This invention concerns a plant pot, particularly for house plants, that has an outer pot that is open on top, and that at least partially surrounds an interior space, whereby the outer pot in its lower part is provided with at least two openings for ventilation of the interior space, an inner pot that is open on top for receipt of plant substratum, whereby the inner pot may be inserted into the outer pot, a water receptacle with a water storage area, that is designed in such a way that moisture is exchanged between the inner pot and the water storage area, and a water-refilling element that allows a targeted filling of the water receptacle in the inner pot that is inserted into the outer pot, whereby the inner pot is at least partially arranged inside the interior space that between the inner pot, the water receptacle and the outer pot a space is provided that connects the openings in the lower part of the outer pot and at least one upper opening in the area of the upper edge of the plant pot with one another, and that the inner pot can be removed from the interior space of the outer pot in a planted condition and then re-inserted in it.

The invention has the task of designing a plant pot of the type described at the beginning in such a way that simple and cost-effective production is possible, while at the same time keeping the ventilation and watering aspects.

The invention solves the problem in that the inner pot is inserted into the outer pot and stands above the water receptacle, whereby the base of the inner pot is provided with at least one indentation oriented toward the upper opening of the inner pot. It is advantageous that through this embodiment pursuant to the invention, the manufacturing tolerances are increased and the execution therefore simplified. Too, an inner pot with a plant in it can no longer get wedged against the outer pot, so that the removal of the inner pot from the outer pot is simplified.

An advantageous teaching of the invention provides that the outer pot is constructed in at least two parts, in the form of a casing and a stand. By means of the two-part construction, it is possible, for example, to replace the casing for decorative reasons. Also, the cleaning of the outer pot is more easily possible, since, for example, the pedestal can be cleaned easily, while this is more difficult with a one-piece outer pot.

It is further advantageous that the pedestal has mounting points for the casing. In this way, a secure and slip-free connection between the casing and the pedestal is assured.

A further teaching of the invention provides that the water receptacle is integrated into the stand. In t his way, the number of components uses is reduced.

A further teaching of the invention provides that the water receptacle is provided with centering means for the inner pot. The centering means allow a precise insertion of the inner pot in the outer pot or the stand, whereby in turn, a more precise positioning is made possible and wedging of inner- and outer pot avoided.

It is further advantageous that the water receptacle is provided with an overflow. Through the existence of an overflow, the user can immediately determine if the water storage area of the water receptacle is sufficiently filled, since then the water enters the overflow. The water is preferably placed in the lower areas of the ventilation openings of the outer pot, whereby the overflow, in a particularly preferable embodiment, is segmented. Through this placement in the ventilation openings, it is possible for the user to see directly into the overflow.

It is further advantageous that the water storage area and the overflow are separated from one another by an annular wall. The annual wall provided allows a simple separation to be made.

A further teaching of the invention provides that the upper ventilation openings are placed in a ring that is provided on the inner pot and laterally to the upper rim of the outer pot and/or in a ring that is provided on the outer pot and lateral to the upper rim of the inner pot. In this way, a connection is provided on the upper part between outer- and inner pot and at the same time ventilation of the intermediate space between outer- and inner pot is assured in a simple manner.

Pursuant to a further teaching of the invention, a water level indicator is provided for the water level in the water receptacle, whereby the water level indicator advantageously is placed inside the water refilling element and/or in the upper ventilation openings. By means of the water level indicator, the user of the plant pot can easily determine whether there is still sufficient water in the water receptacle. Advantageously, the water refilling element is provided with an inflow area. The provision of an inflow area makes it easier to refill the water receptacle. The water refilling element is thus advantageously placed in the inner area of the inner pot in a mounting area provided for it, which preferably is a recess. The water refilling element also consists of a dividing element that advantageously forms a closed canal with the wall of the inner pot. In a particularly advantageous embodiment, the wall of the inner pot is not provided with openings in the receptacle area for the water refilling element.

Further, the dividing wall is designed as a cylindrical casing surface element. By means of the provision of a recess in the inner pot and of a separate dividing element, the advantage is created that the inner pot and the dividing element can be more easily manufactured, since the tools for this are easier to produce. At the same time, however, the function of reliable refilling is assured.

Further, the water transport means between water receptacle and inner pot, such as, for example, fibers or clay elements may be provided, through which additional transfer of water into the inner pot is achieved.

It is further advantageous that the height of the indentation that is oriented toward the upper opening of the inner pot is greater than the maximum height of the water level in the water storage area of the water receptacle. If the depth of the indentation is greater than the height of the annular wall, this prevents the lower area of the inner pot from standing in water, whereby accumulated water is prevented. At the same time, an overflow over the annular wall of excess water added to the water receptacle is made possible by means of the fact that the indentation is deeper than the height of the annular wall, and thus there is a space between the annular wall and the base.

### BRIEF DESCRIPTION OF THE DRAWINGS

The invention will be explained in greater detail below using one sample embodiment, accompanied by the drawings. The drawings show:

FIG. 1 a spatial representation of a plant pot pursuant to the invention,

FIG. 2 a lateral view of the component of the plant pot pursuant to the invention,

FIG. 3a a top view of a casing of an outer pot pursuant to the invention,

FIG. 3b a lateral view of FIG. 3a,

FIG. 4a a lateral view of an inner pot of a plant pot pursuant to the invention,

FIG. 4b a spatial view of FIG. 4a,

FIG. 4c a top view of FIG. 4a,

FIG. 5a a bottom view of a pedestal of a plant pot pursuant to the invention,

FIG. 5b a sectional view through a pedestal pursuant to FIG. 5a,

FIG. 5c a top view of the pedestal pursuant to FIG. 5a,

FIG. 6a a spatial representation of a water refilling element of a plant pot pursuant to the invention,

FIG. 6b an enlarged view of a section of FIG. 6a,

FIG. 7 a spatial representation of an inner pot with water refilling element and water level indicator of a plant pot pursuant to the invention

FIG. 8 a sectional view of a spatial representation of a second sample embodiment of a plant pot pursuant to the invention,

FIG. 9a a lateral view of an inner pot of a second embodiment of a plant pot pursuant to the invention

FIG. 9b a top view of FIG. 9a, and

FIG. 10 a top view of a casing of a second embodiment of a plant pot pursuant to the invention.

### DETAILED DESCRIPTION

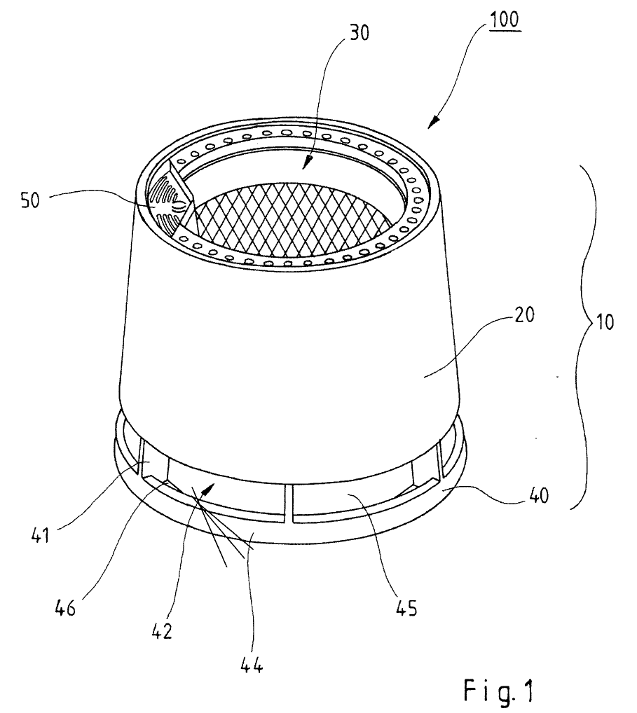

FIG. 1 shows a plant pot 100 pursuant to the invention, consisting of an outer pot 10 and an inner pot 30, whereby a water refilling element 50 is provided in the inner pot 30. The outer pot 10 consists of a casing 20 and a pedestal 40, here also as water receptacle, whereby the casing 20 is placed detachably on the pedestal 40.

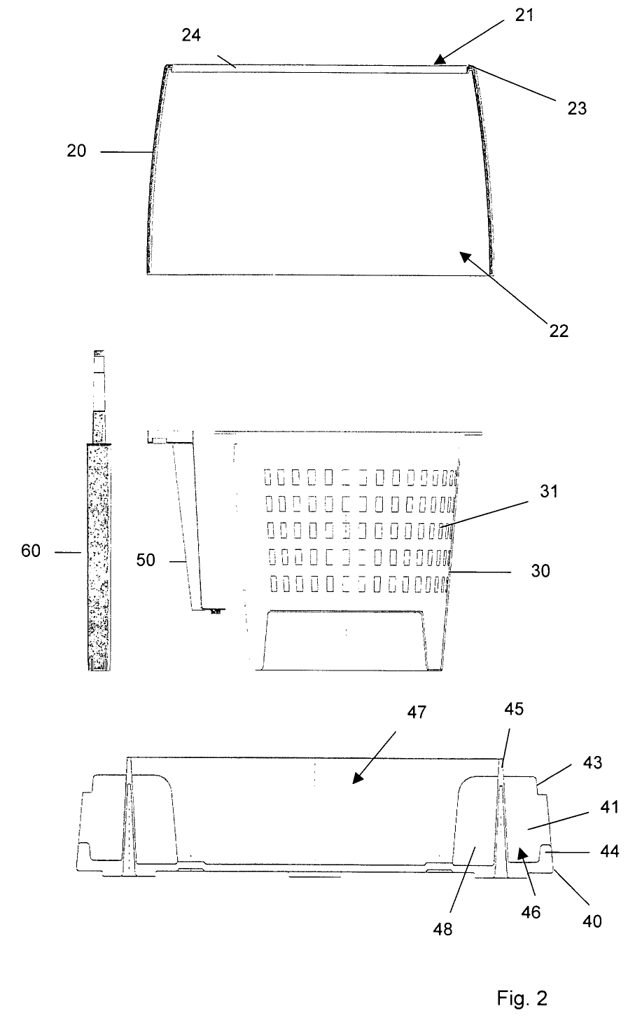

The pedestal 40 is provided with bars 41, which are arranged around the circumference of the pedestal 40. The bars 41 have mountings 43 on their upper ends (see FIG. 2).

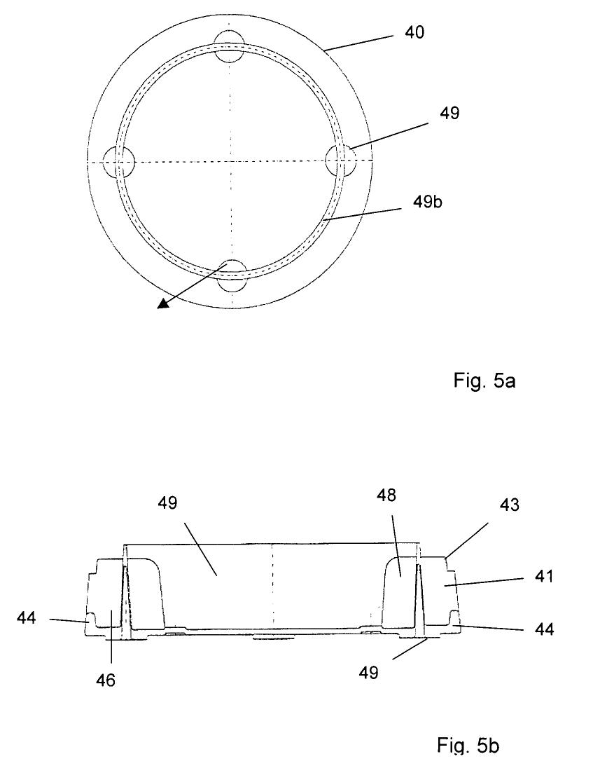

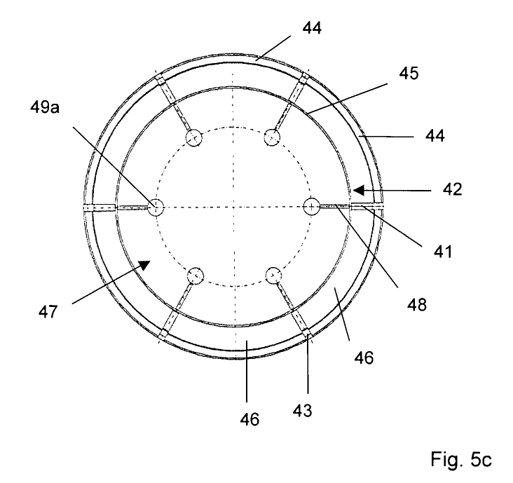

The outer rim of the pedestal 40 is provided with a circular edge 44. An annular wall 45 is placed so that it is spatially divided from the circular edge 44 (see also FIGS. 2 and 5b and 5c).

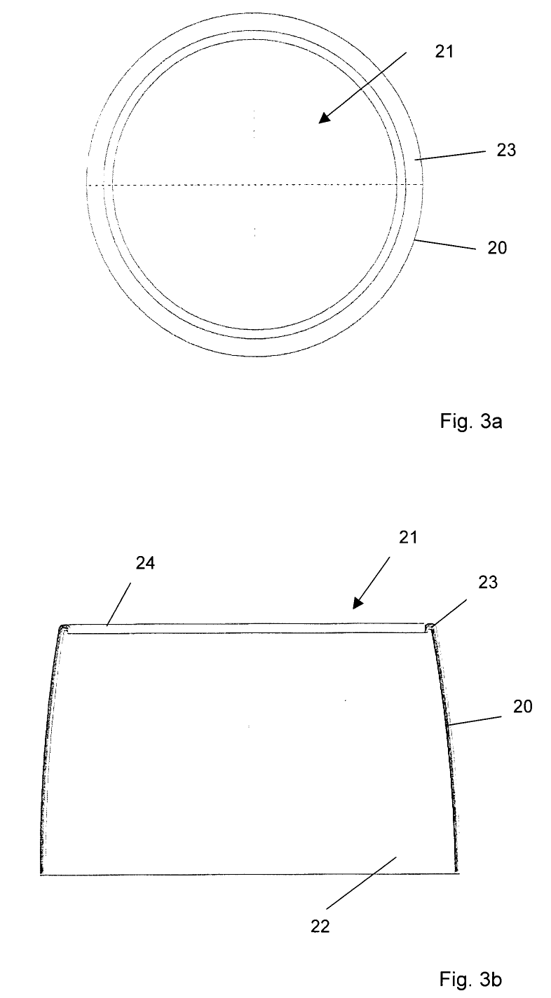

The casing 20 consists of a conical cylindrical casing element tapered toward the top, that has an upper opening 21 and a lower opening 22 (see FIGS. 3a and 3b). The casing 20 has an upper rim 23, that has an inward-curving cut 24, that allows a secure insertion of the inner pot 30 into the casing 20, and prevents wedging between casing 20 and inner pot 30.

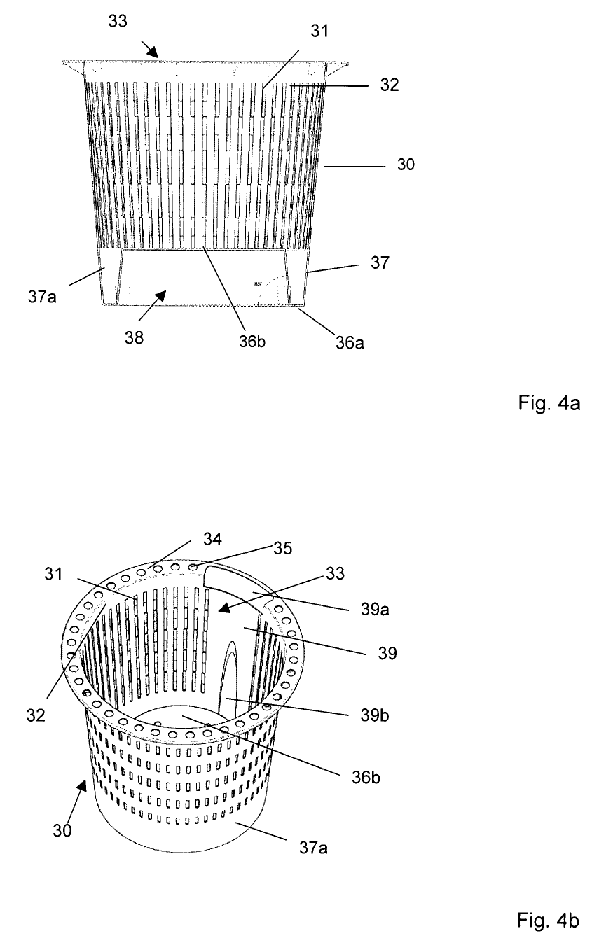

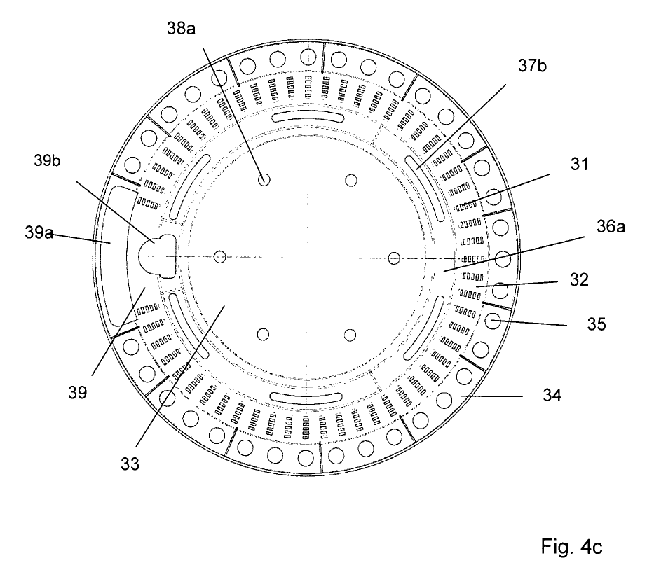

The inner pot 30 (see FIG. 2 and FIG. 4a to 4c) has ventilation openings 31 in its circular side wall 32. The upper part of the inner pot 30 has an opening 33, through which the plant substratum (not shown) is introduced into the inner pot 30. On the upper end of the inner pot 30, an outer-facing edge 34 is provided, which has openings 35. The openings 35 serve as air outlet openings for the air that enters through the ventilation openings 42 in the lower part of the plant pot 100 and that rises through a flue-like intermediate space. The inner pot 30 has a base 36 that is divided into two sections 36a and 36b. Section 36a is the base, which belongs to the stand sections 37 of the inner pot 30. The stand section 37 has walls 37a that are provided with openings for ventilation. The base section 36a is provided with openings 37b, through which the water can penetrate. This is, for example, water that is placed directly in the plant substratum, in order to prevent water accumulating in the lower part of the plant pot. The base section 36b represents the upper part of the indentation 38. The indentation 38 is set into the base of the plant pot, from the base, seen through opening 33.

Furthermore, the inner pot, on its wall 32, has a recessed section 39, which is provided with openings 31. Section 39 has two recesses 30a and 39b, whereby the recess 39a relates to the upper rim 34 and the upper part of the wall 32, and the recess 39b extends from the base 36 elliptically along the recessed section 39.

The base section 36b of the indentation 38 is provided with openings 38a, which also again serve as a water outlet, but at the same time also for lower ventilation of the inner pot 30.

The pedestal 40 is illustrated using FIGS. 5a, 5b and 5c. Between the circular edge 44 and the annular wall 45, there is the overflow 46. The water storage area 47 is defined by the annular wall 45. Inside the water storage area 47, centering means 48 are provided, which assure the correct placement of the inner pot 30 inside the pedestal 40 and thus also inside the outer pot 10. On the underside of the pedestal 40 are alignment elements 49. The alignment elements 49 are connected to an alignment circle 49b. In the water storage area 47 there are alignment elements 49a, on which the inner pot 30 stands, so that between the base of the pedestal 40 in the water storage area 47, between the alignment elements 49a, an opening is formed through which water can penetrate. The pedestal 40 is represented in FIGS. 5a to 5c.

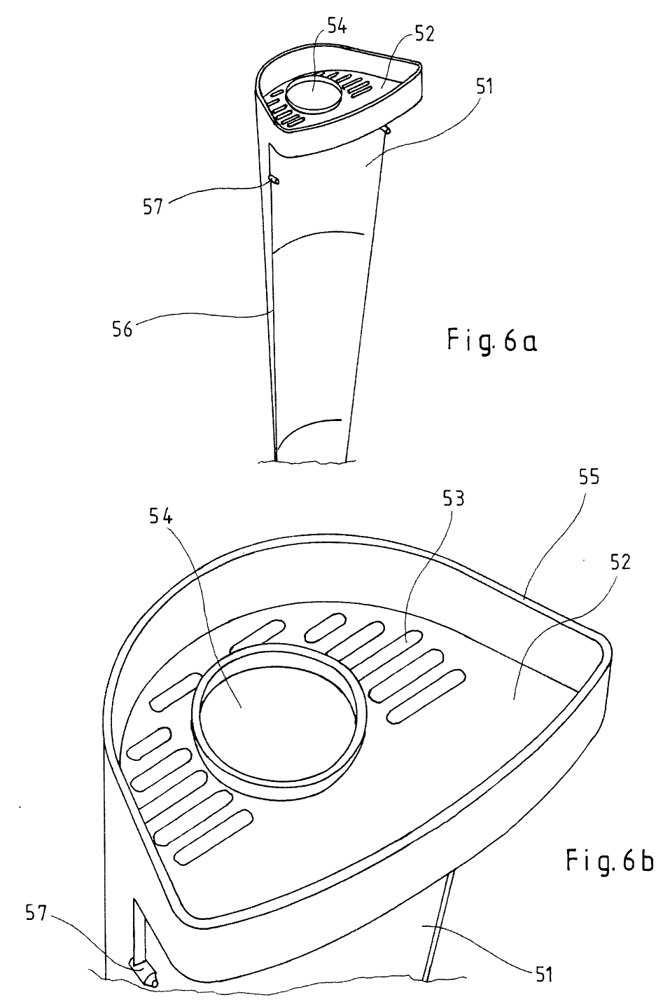

FIGS. 6a and 6b show the water refilling element 50, which is also shown in FIG. 2. The water refilling element 50 consists of a cylindrical casing surface element 51 as a dividing element, and a inflow area 52. The inflow area 52 is provided with openings 53, through which the water poured into the inflow area 52 can penetrate. Furthermore, the inflow area 52 has an opening 54, through which the water level indicator 60 is inserted. The inflow area 52 is surrounded by the wall 55. On the outer edges 56 of the cylindrical casing surface element 51, holding pins 57 are arranged, that can be inserted into openings 31 in the inner pot 30.

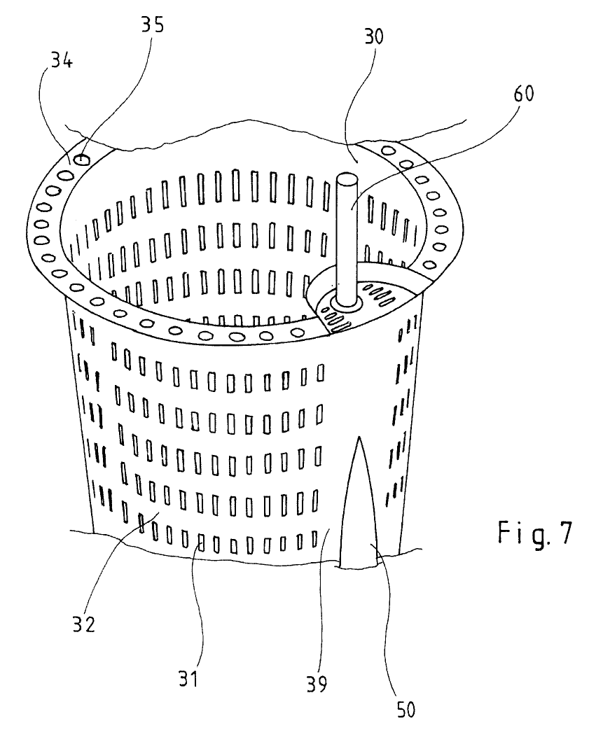

FIG. 7 shows the arrangement of the inner pot 30 with the water refilling element 50 and the water level indicator 60 inserted in it.

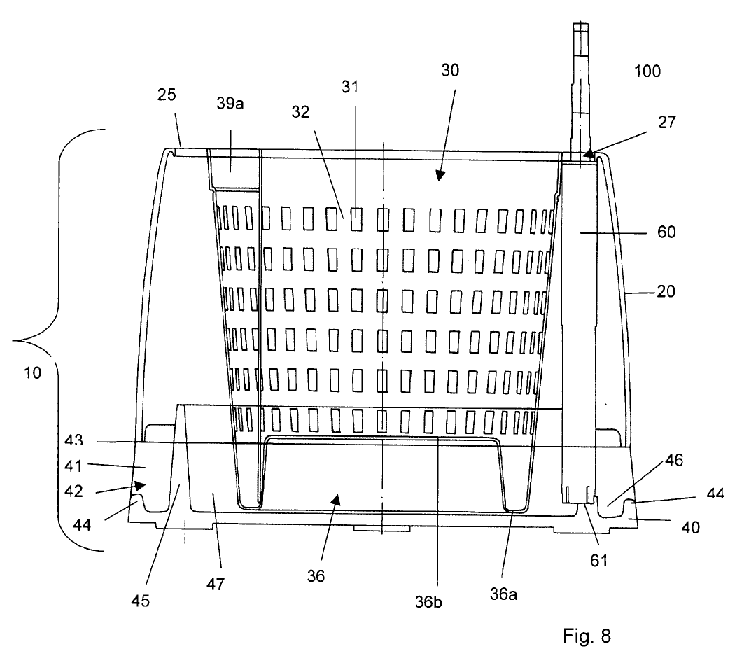

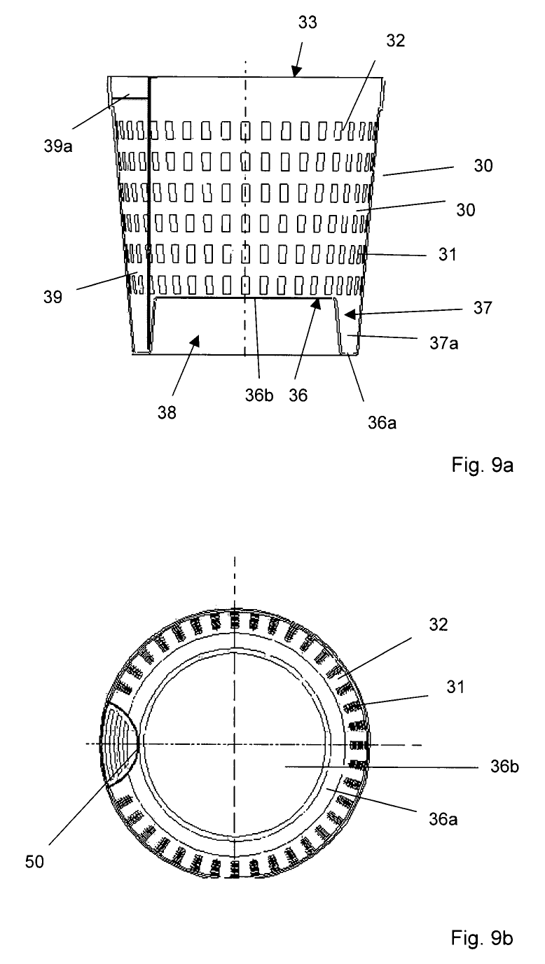

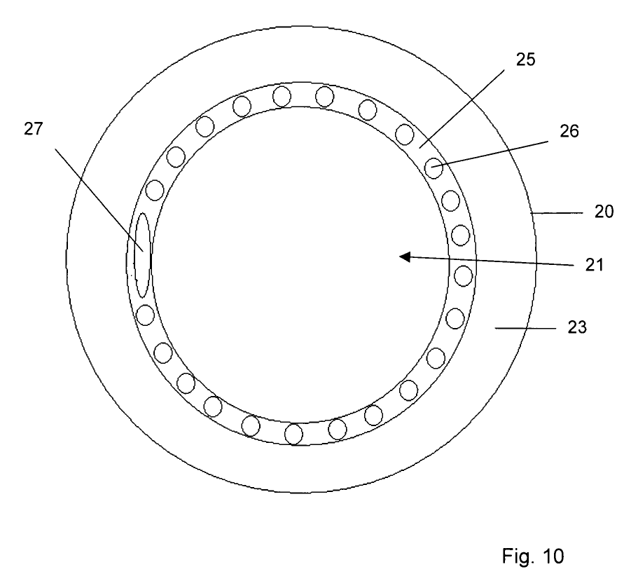

FIG. 8 shows a sectional lateral view of a second embodiment of a plant pot 100. On a pedestal 40, an outer casing 20 is placed, in which an inner pot 30 is inserted. The pedestal 40 also has a water level indicator 47, which is formed by a water curtain 45. In the water curtain 45, a recess 61 for the water level indicator 60 is provided. The outer casing 20 is provided with a rim 25 that inclines inward, in which there are ventilation openings 26 and a receptacle opening 27 for the water level indicator 60 (see FIG. 10). The inner pot 30 is designed without a rim and inserted in the rim 25 of the outer casing 20 that inclines inward and is again centered by means of the centering means 48 in water storage area 47. The inner pot 30 is represented in FIGS. 9a and 9b as a second embodiment without a rim. In FIG. 9b a top view may be seen, in which once again a water refilling element 50 is inserted in the inner pot. The rimless embodiment of the inner pot 30 may be seen again in FIG. 9a. The inner pot also has a recess 39 for the water refilling element 50 with a first recess 39a in the area of the upper opening 33.

1-16. (canceled)

17. A plant pot, particularly for house plants, comprising:
an outer pot having an outer open top, a lower part, at least two ventilation openings in the lower part, and an outer pot rim, the outer pot at least partially defining an outer interior space;
an inner pot having an inner open top for receipt of plant substratum, a wall, a base, at least one indentation in the base open to the inner open top, an inner pot rim, and at least one inner pot rim opening, the inner pot being sized to fit within the outer pot and at least partially defining an inner interior space;
a water receptacle having a water storage area for the exchange of moisture between the inner pot and the water storage area, the water storage area having a maximum water level; and
a water-refilling element for a targeted filling of the water receptacle;
wherein the inner pot can be at least partially arranged inside the outer interior space such that a space is provided between the inner pot and the outer pot that connects the at least two ventilation openings with the at least one inner pot rim opening;
wherein the inner pot can be removed from the outer interior space in a planted condition and subsequently re-inserted whereby the inner pot is disposed within the outer pot and upon the water receptacle.

18. The plant pot as claimed in claim 17, wherein the outer pot further comprises a casing and a pedestal, wherein the outer pot is constructed from at least the casing and the pedestal.

19. The plant pot as claimed in claim 18, wherein the pedestal further comprises one or more stand mounting parts to support the casing.

20. The plant pot as claimed in claim 18, wherein the water receptacle is integrated into the pedestal.

21. The plant pot as claimed in claim 17, wherein the water receptacle further comprises a centering means to center the inner pot.

22. The plant pot as claimed in claim 17, wherein the water receptacle further comprises an overflow.

23. The plant pot as clamed in claim 22, wherein the overflow is arranged in the lower part of the outer pot, the lower part being segmented.

24. The plant pot as clamed in claim 22, further comprising an annular wall that separates the water storage area and the overflow.

25. The plant pot as claimed in claim 17, wherein the at least one inner pot rim opening is arranged in the inner pot rim and laterally from the outer pot rim.

26. The plant pot as claimed in claim 17, further comprising at least one outer pot rim opening arranged in the outer pot rim and laterally from the inner pot rim.

27. The plant pot as claimed in claim 17, further comprising a water level indicator in the water receptacle.

28. The plant pot as claimed in claim 27, wherein the water level indicator is disposed inside the water-refilling element.

29. The plant pot as claimed in claim 27, further comprising at least one outer pot rim opening wherein the water level indicator is disposed in the at least one outer pot rim opening.

30. The plant pot as claimed in claim 27, wherein the water level indicator is disposed in the at least one inner pot rim opening.

31. The plant pot as claimed in claim 17, wherein the water-refilling element further comprises an inflow element.

32. The plant pot as claimed in claim 17, further comprising an intake area being a recess, wherein the water-refilling element is disposed in the intake area in the inner interior space.

33. The plant pot as claimed in claim 32, wherein the wall of the inner pot proximate to the inflow area is not provided with openings.

34. The plant pot as claimed in claim 17, wherein the water-refilling element further comprises a dividing element that forms a closed canal with the wall of the inner pot.

35. The plant pot as claimed in claim 34, wherein the dividing element is a cylindrical casing surface element.

36. The plant pot as claimed in claim 18, wherein the casing comprises a top and a bottom, the bottom being wider than the top, the bottom being substantially conically shaped.

37. The plant pot as claimed in claim 17, wherein the height of the at least one indentation is greater than the maximum water level.

38. A plant pot, particularly for house plants, comprising:
an outer pot having an outer open top, a lower part, at least two ventilation openings in the lower part, and an outer pot rim, the outer pot at least partially defining an outer interior space;
an inner pot having an inner open top for receipt of plant substratum, a wall, a base, at least one indentation in the base open to the inner open top, an inner pot rim, and at least one inner pot rim opening, the inner pot being sized to fit within the outer pot and at least partially defining an inner interior space;
a water receptacle having a water storage area; and
a water-refilling element;
wherein the inner pot can be at least partially arranged inside the outer interior space such that a space is provided between the inner pot and the outer pot that connects the at least two ventilation openings with the at least one inner pot rim opening.
